(19) United States
(12) Patent Application Publication
(10) Pub. No.: US 2025/0319849 A1
(43) Pub. Date: Oct. 16, 2025

(54) CLEANING DEVICE FOR RIMS

(71) Applicant: Edgar Chapman, GENOA, IL (US)

(72) Inventor: Edgar Chapman, GENOA, IL (US)

(21) Appl. No.: 19/037,619

(22) Filed: Jan. 27, 2025

Related U.S. Application Data
(60) Provisional application No. 63/632,310, filed on Apr. 10, 2024.

(51) Int. Cl. B60S 3/04; B08B 1/10; B08B 1/30; B25G 1/04

(52) U.S. Cl. CPC B60S 3/042; B08B 1/10; B08B 1/30; B25G 1/04; B60S 3/045

(57) ABSTRACT

A cleaning device for cleaning barrels of rims. The cleaning device includes a curved blade having an inner side and an outer side; a rod hingedly coupled to the inner side of the curved blade; and a cleaning pad coupled to the outer side of the curved blade. The rod can pivot transversely to the longitudinal axis of the curved blade, the longitudinal axis is along a length of the curved blade.

### CROSS-REFERENCE TO RELATED APPLICATIONS

This application claims priority from a U.S. Provisional Patent Appl. No. 63/632,310, filed on Apr. 10, 2024, which is incorporated herein by reference in its entirety.

### FIELD OF INVENTION

The present invention relates to a cleaning device for rims, and more particularly, the present invention relates to a cleaning device for cleaning a barrel of an automobile's rim.

### BACKGROUND

Keeping automobiles clean is an essential task for automobile owners. Customized tools are available for cleaning different parts of automobiles, such as a car. Some parts of automobiles are more difficult to clean than other parts. In particular, the wheels of an automobile are difficult to clean due to hard-to-reach areas in the wheel. Spokes of the rim severely limit access to the barrel for cleaning. People often hurt their hands while cleaning the barrel. Automobile owners always desire cleaning and shining barrels.

Thus, a need is therefore appreciated for a cleaning device for cleaning barrels of a rim.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a cleaning device for cleaning a barrel of an automobile's rim.

Another object of the present invention is that the cleaning device can easily reach the barrel through the spokes of the rim.

Still, another object of the present invention is that the cleaning device can efficiently clean the barrel.

Yet another object of the present invention is that the cleaning device is easy to use.

A further object of the present invention is that the cleaning device is economical to manufacture.

In one aspect, disclosed is a cleaning device for rims, the cleaning device comprises a curved blade having an inner side and an outer side; a rod hingedly coupled to the inner side of the curved blade, wherein the rod is configured to pivot transversely to a longitudinal axis of the curved blade, the longitudinal axis is along a length of the curved blade; and a cleaning pad configured to interchangeably coupled to the outer side of the curved blade. The cleaning device further comprises a hinge connector of a T-shape, wherein the rod is coupled to the curved blade through the hinge connector. The cleaning device further comprises an extension rod configured to couple to the rod to increase the effective length of the rod. The cleaning device comprises a bracket coupled to the inner side of the curved blade, wherein the hinge connector is coupled to the bracket.

In one aspect, disclosed is a method for cleaning barrels of a rim, the method comprises providing a cleaning device. The cleaning device comprises a curved blade having an inner side and an outer side; a rod hingedly coupled to the inner side of the curved blade, wherein the rod is configured to pivot transversely to a longitudinal axis of the curved blade, the longitudinal axis is along a length of the curved blade; and a cleaning pad configured to interchangeably be coupled to the outer side of the curved blade. The method further comprises inserting the curved blade through spokes of the rim, and placing it over a barrel of the rim; and moving the curved blade left and right over the barrel.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows a perspective view of a cleaning device, according to an exemplary embodiment of the present invention.

FIG. 2 shows another perspective view of the cleaning device, according to an exemplary embodiment of the present invention.

FIG. 3 shows an exploded view of the cleaning device, according to an exemplary embodiment of the present invention.

FIG. 4 shows a hinge connector of the cleaning device, according to an exemplary embodiment of the present invention.

FIG. 5 shows a curved blade of the cleaning device, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the allowed claims of any resulting patent will best define the scope of the invention.

Disclosed is a cleaning device for cleaning the barrels of rims of automobiles, such as that of cars. The cleaning device provides easier and more efficient cleaning of the barrel providing a tidy and shiny barrel surface. The cleaning head of the cleaning device can be easily inserted through spaces within the spokes. Also, the cleaning head has a large surface area that can contact the rim surface for more efficient and quicker cleaning.

The cleaning head has a curved flat surface effectively having 100% contact with the surface of the barrel, resulting in quicker and tidier cleaning. Also, the cleaning device allows for cleaning between the calipers and emergency brakes, and the inside of the barrel. The cleaning device can clean approximately 30% of the inside barrel while placing it between only two spokes. The cleaning device may ensure complete cleaning of the hard-to-reach dirty patches on the inside barrel behind the spokes which is hard to reach with conventional cleaning tools. Different cleaning pads can be put on the cleaning head, thus making the cleaning device versatile. For example, different pads for cleaning, drying, dusting, and surface protection applications can be used.

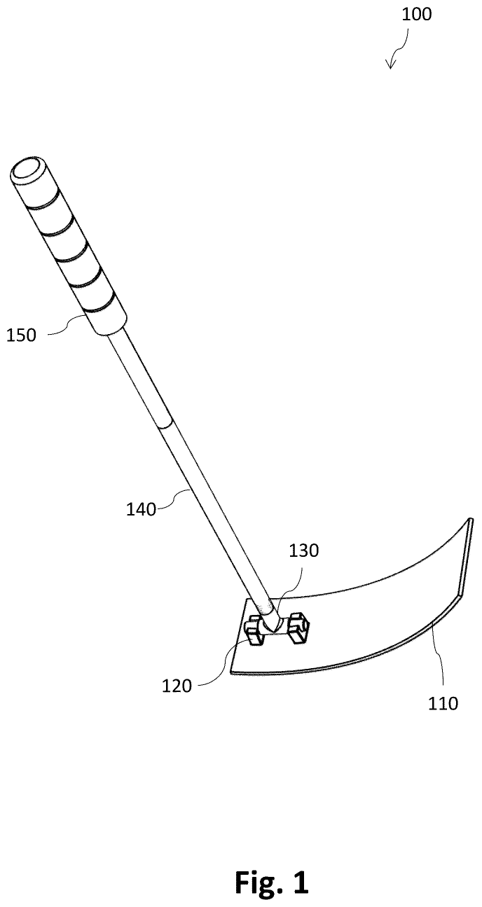

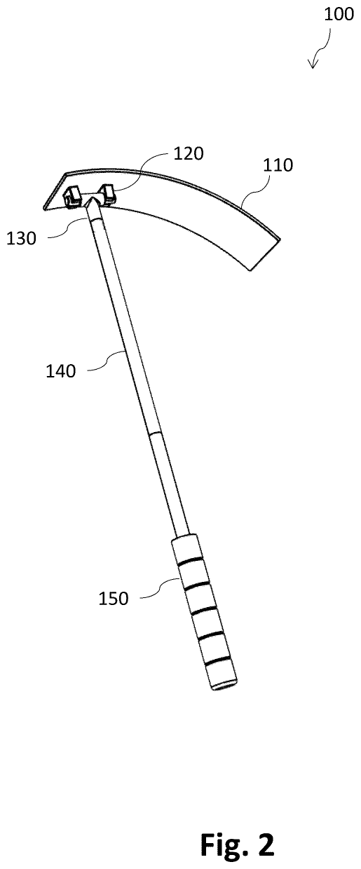

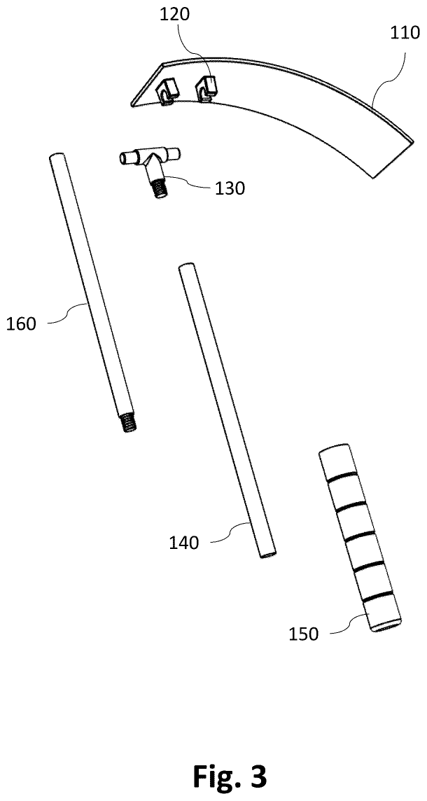

Referring to FIGS. 1-3 showing different aspects of the cleaning device 100. The cleaning device 100 includes a curved blade 110, a pair of brackets 120 integral with the curved blade 110, a hinge connector 130 configured to be hingedly coupled to the pair of brackets 120, a rod 140 coupled to the hinge connector 130, and a handle 150 coupled to an end of the rod 140.

The curvature of the curved blade 110 corresponds to the diameter of the rim for a perfect surface match. For example, the blade 110 may be adapted for different rim sizes, such as 18″, 20″ and 22″. It is to be noted that the curved blade can flex to match the rim diameter to certain degrees.

In certain implementations, the curved blade may be 2¾″ wide and have a 12-14″ flat surface. It is to be noted that the dimensions may vary without departing from the scope of the present invention and may correspond to the dimensions of a rim. The curved blade may be made from a flexible material, such that it can be flexed a little under pressure. Examples of such materials include plastic; however, any suitable material can be used to make the curved blade, and any such material is within the scope of the present invention.

On the inner side of the curved blade 110 may be a pair of spaced-apart brackets 120. The brackets 120 can be attached to the curved blade 110, for example, through an adhesive. The brackets 120 can also be made integral with a curved blade 110. Each bracket has a receiving member 125 in the form of a clamp. The receiving member 125 can receive a tubular rod and secure the same using the snap-fit mechanism. The opposite walls of the receiving member 125 can flex outwards to receive the tubular rod and then regain shape to secure the tubular member. The tubular member can rotate with respect to the receiving member. It is to be noted that any other fastening mechanism for hingedly coupling a hinge connector to the blade is within the scope of the present invention.

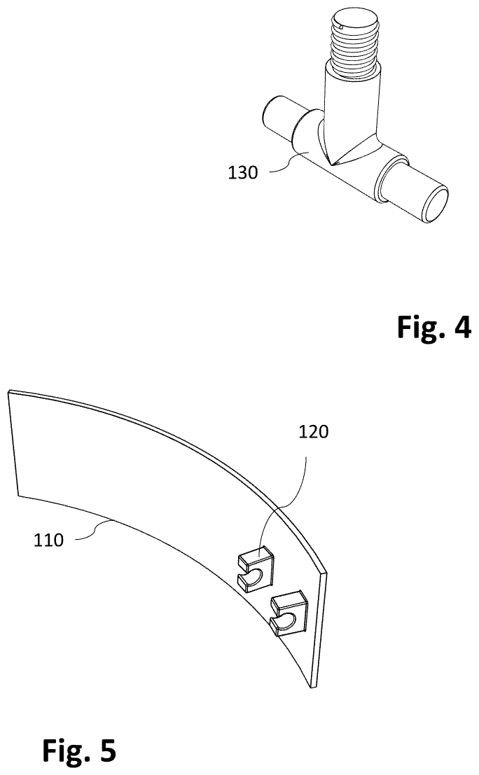

The cleaning device 100 further includes a hinge connector 130. The hinge connector 130, more clearly shown in FIG. 4, is of a T-shape. The hinge connector 130 has a tubular member that can be mounted to the brackets 120. The tubular member can snap-fit into the brackets and can rotate transversely with respect to the curved blade 110. The hinge connector can rotate about 180 degrees left and right of the curved blade. The vertical leg of the hinge connector has a joint for connecting to the rod 140. The end of the rod 140 may include a handle 150 for gripping the cleaning device 100. One or more extension rods 160 may be incorporated to increase or decrease the length of the rod 140.

The cleaning device may further include cleaning pads that could be slipped on the curved blade. The cleaning pads can be interchangeably used depending upon the intended use. For example, different cleaning pads could be for cleaning, drying, dusting, and polishing. The cleaning pad may have pockets at corners and along the periphery, which can be put on the curved blade. The cleaning pad can be attached to the blade using any suitable fastening mechanism. For example, adhesives can be used to attach a cleaning pad. Hook and loop fasteners can be used to attach a cleaning pad. Also, snap-fit buttons can be used to attach a cleaning pad. Thus, any suitable fastening mechanism can be used without departing from the scope of the present invention.

In use, a user can slip a cleaning pad on the curved blade. Thereafter, the cleaning blade can be inserted through the spokes and positioned over the barrel. The handle can be rotated downwards. The cleaning device can then be moved over the barrel left and right for cleaning. This allows the user to clean from 20-22″ approximately 30% of the rim barrel while placing the handle between only two spokes of the wheel. Length of the rod can be adjusted from 12-20″ to allow the cleaning from the front of the wheel barrel to the back of the wheel barrel on very wide rims.

In certain implementations, the arc length and curve angle of the curved blade can be adapted according to the barrel radius. For example, for a wheel specification that has an 18-inch outer diameter, 53.4 inches inside circumference, and 8.5 inches barrel radius, the blade can have an arc length of 11 inches, a curved angle of 74.1 degrees, and a width of 2.5 inches. Similarly, for a wheel specification that has 20 inches outer diameter, 59.7 inches inside circumference, and 9.5 inches barrel radius, the blade can have an arc length of 12 inches, a curved angle of 72.4 degrees, and a width of 2.5 inches. Also, for a wheel specification that has 22 inches outer diameter, 66.0 inches inside circumference, and 10.5 inches barrel radius, the blade can have an arc length of 13 inches, a curved angle of 70.9 degrees, and a width of 2.5 inches.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A cleaning device for rims, the cleaning device comprising:
a curved blade having an inner side and an outer side;
a rod hingedly coupled to the inner side of the curved blade, wherein the rod is configured to pivot transversely to a longitudinal axis of the curved blade, the longitudinal axis is along a length of the curved blade; and
a cleaning pad configured to interchangeably coupled to the outer side of the curved blade.

2. The cleaning device of claim 1, wherein the cleaning device further comprises:
a hinge connector of a T-shape, wherein the rod is coupled to the curved blade through the hinge connector.

3. The cleaning device of claim 2, wherein the cleaning device further comprises:
an extension rod configured to couple to the rod for increasing an effective length of the rod.

4. The cleaning device of claim 3, wherein the cleaning device comprises a bracket coupled to the inner side of the curved blade, wherein the hinge connector is coupled to the bracket.

5. A method for cleaning barrels of a rim, the method comprises:
providing a cleaning device comprising:
a curved blade having an inner side and an outer side;
a rod hingedly coupled to the inner side of the curved blade, wherein the rod is configured to pivot transversely to a longitudinal axis of the curved blade, the longitudinal axis is along a length of the curved blade; and
a cleaning pad configured to interchangeably be coupled to the outer side of the curved blade;
inserting the curved blade through spokes of the rim, and placing it over a barrel of the rim; and
moving the curved blade left and right over the barrel.

6. The method of claim 5, wherein the cleaning device further comprises:
a hinge connector of a T-shape, wherein the rod is coupled to the curved blade through the hinge connector.

7. The method of claim 6, wherein the cleaning device further comprises:
an extension rod configured to couple to the rod for increasing an effective length of the rod.

8. The method of claim 6, wherein the cleaning device comprises a bracket coupled to the inner side of the curved blade, wherein the hinge connector is coupled to the bracket.
